(19) United States
(12) Patent Application Publication
(10) Pub. No.: US 2016/0306554 A1
(43) Pub. Date: Oct. 20, 2016

(54) DATA STORAGE MANAGEMENT

(71) Applicant: EMC CORPORATION, Hopkinton, MA (US)

(72) Inventors: Sanping Li, Beijing (CN); Yu Cao, Beijing (CN); Hui Liu, Westborough, MA (US); Xiaoyan Guo, Beijing (CN); Zhe Dong, Beijing (CN); Jun Tao, Shanghai (CN); Vivian Wenwen Gao, Beijing (CN)

(21) Appl. No.: 15/096,646

(22) Filed: Apr. 12, 2016

(30) Foreign Application Priority Data
Apr. 17, 2015 (CN) CN2015101849000

(51) Int. Cl. G06F 3/06

(52) U.S. Cl. CPC G06F 3/0604; G06F 3/0619; G06F 3/0653; G06F 3/0683; G06F 3/0647; G06F 3/065

(57) ABSTRACT

Embodiments of the present disclosure relate to a data storage management method and system that is configured to: to monitor access conditions of data stored in a plurality of storage devices, wherein the plurality of storage devices are divided into a plurality of storage device tiers based on their respective characteristics; determine active degrees of the respective data based on the access conditions of the respective data; control movement of the respective data among the plurality of storage device tiers based on the active degrees of the respective data, such that the respective data are stored in the storage device tiers adapted to their respective active degrees.

### RELATED APPLICATION

This application claim priority from Chinese Patent Application Number CN2015101849000, filed on Apr. 17, 2015 at the State Intellectual Property Office, China, titled “DATA STORAGE MANAGEMENT SYSTEM AND METHOD,” the contents of which is herein incorporated by reference in entirety.

### DISCLAIMER

Portions of this patent document/disclosure may contain command formats and other computer language listings, all of which are subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Embodiments of the present disclosure relate to the field of data storage.

### BACKGROUND OF THE INVENTION

Currently, network speed are rapidly increasingly, and with emergence of a super high-speed network, various applications and services constantly surge and change accordingly; however, a number of devices accessing a network may also be constantly increasing, which gives rise to a need for expeditious creation of mass data. In order to adapt to such situation, technologies such as data lakes have been developed for processing and storing these surging mass data. However, from the perspective of data center, there still remains a big challenge on how to perform real-time data storage and analysis for such mass data, where current data storage solutions may not satisfy real-time storage and high-performance analysis.

### SUMMARY OF THE INVENTION

Exemplary embodiments of the present disclosure provided a solution for data storage management in terms of a data storage management system. The data storage management system comprises: a data access monitor configured to monitor access conditions of data stored in a plurality of storage devices, wherein the plurality of storage devices are divided into a plurality of storage device tiers based on their respective characteristics; an active degree meter configured to determine active degrees of respective data based on access conditions of the respective data; a data movement controller configured to control movement of the respective data among the plurality of storage device tiers based on the active degrees of the respective data, such that the respective data are stored in the storage device tiers adapted to their respective active degrees.

### BRIEF DESCRIPTION OF THE DRAWINGS

Features, advantages, and other aspects of various embodiments of the present disclosure will become more apparent with reference to the following detailed description in conjunction with the accompanying drawings, wherein:

FIG. 1 schematically shows an exemplary block diagram of a data storage management system according to one embodiment of the present disclosure;

FIG. 2 schematically shows an exemplary diagram of data active degree division according to one embodiment of the present disclosure;

FIG. 3 schematically shows an exemplary diagram of storage device tier division according to one embodiment of the present disclosure;

FIG. 4 schematically shows an exemplary diagram of data storage management system according to a specific implementation of the present disclosure;

FIG. 5 schematically shows an exemplary flow diagram of a data storage management method according to one embodiment of the present disclosure; and

FIG. 6 shows an exemplary structural block diagram of a computer device in which embodiments of the present disclosure may be implemented.

### DETAILED DESCRIPTION

Hereinafter, various exemplary embodiments of the present disclosure will be described in detail with reference to the accompanying drawings. It should be noted that these figures and description are only presented as exemplary embodiments. It should also be noted that one can easily conceive alternative embodiments of the structure and method disclosed herein, and these alternative embodiments may be used without departing from the principle of the disclosure as claimed herein.

It should be understood that these exemplary embodiments provided here are only for enabling those skilled in the art to better understand and then further implement the present disclosure, not intended to limit the scope of the present disclosure in any manner. Besides, in the accompanying drawings, for a purpose of illustration, alternative steps, modules, and units may be illustrated in dotted-line blocks. Herein, recitations such as “one embodiment,” “further embodiment,” or “a preferred embodiment” and the like indicate that the embodiment as described may comprise specific features, structures or characteristics, but each embodiment does not necessarily include such specific features, structures or characteristics. Moreover, these terms do not necessary refer to the same embodiment. The terms “comprise(s),” “include(s),” and like expressions used herein should be understood as open terms, i.e., “comprising/including, but not limited to.” The term “based on” means “at least partially based on.” The term “one embodiment” indicates “at least one embodiment”;

the term “another embodiment” indicates “at least one another embodiment.” Relevant definitions of other terms will be provided in the description below. It should be further understood that various terms used herein are only used to describe an objective of a specific example, not intended to limit the present disclosure. For example, the singular form “a” and “the” used herein may comprise a plural form, unless otherwise explicitly indicated in the context. It should also be understood that the terms “include,” “have” and “comprise” used herein indicate existence of the features, units and/or components, but do not exclude existence of one or more other features, units, components and/or their combination. For example, the term “multiple” used here may indicate “two or more.” The term “and/or” as used herein may comprise any and all combinations of one or more of various items listed in association. Definitions of other terms will be provided specifically hereinafter.

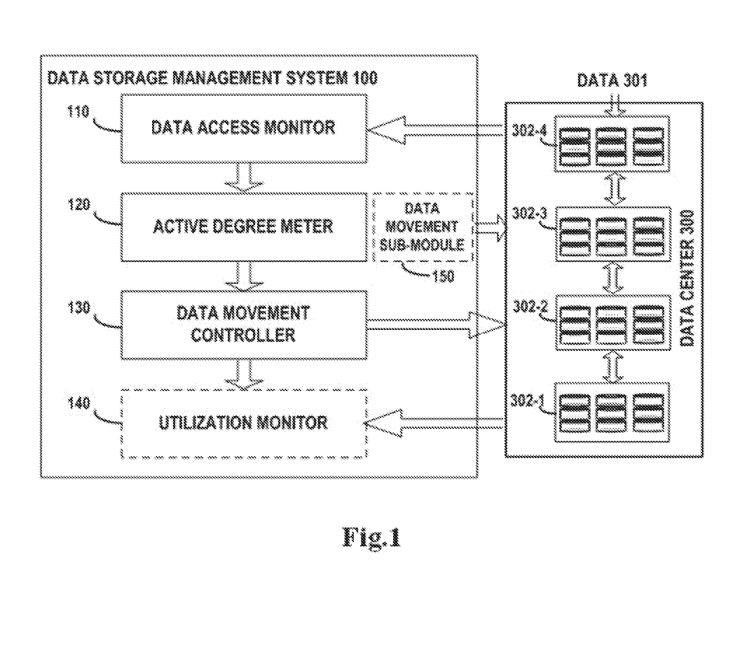

Hereinafter, a technical solution for data storage management according to the embodiments of the present disclosure will be described in detail by means of the embodiments with reference to the accompanying drawings. Currently data storage technologies cannot simultaneously support real-time data storage and high-performance analysis for high-rocketing mass data. To this end, the present disclosure provides a solution for data storage management so as to allow high-performance data analysis while supporting real-time data storage. Hereinafter, embodiments of the present disclosure will be described in detail with reference to FIGS. 1-6 and the claims.

Exemplary embodiments of the present disclosure provided a solution for data storage management in terms of a data storage management system. In one embodiment, a data storage management system may include a data access monitor that may be configured to monitor access conditions of data stored in a plurality of storage devices. In a further embodiment, a plurality of storage devices may be divided into a plurality of storage device tiers based on their respective characteristics. A further embodiment may include an active degree meter that may be configured to determine active degrees of respective data based on access conditions of respective data. A further embodiment may include a data movement controller that may be configured to control movement of respective data among a plurality of storage device tiers based on active degrees of the respective data, such that the respective data may be stored in a storage device tiers adapted to their respective active degrees.

In one embodiment, a plurality of storage device tiers may at least include a real-time processing storage tier, a high-performance storage tier, a large-capacity storage tier, and an archive storage tier, whose tiers may be ranked in a descending order. In a further embodiment a data movement controller may be configured to store relatively active data in a higher-tier storage device and store less active data in a lower-tier storage device.

In a further embodiment, an active degree meter may be configured to determine active degrees of respective data by determining most recently use MRU values of the respective data. In a further embodiment, an active degree meter may be configured to, when data is written into a real-time processing storage tier, assign an initial value to an MRU value of a data, and when data stored in a real-time processing storage tier or a high-performance storage tier is accessed, decrease an MRU value of the data, and when data stored in a large-capacity storage tier or an archive storage tier is accessed, increase an MRU value of the data, and when data stored in a large-capacity storage tier is not accessed within a predetermined time period, decrease an MRU value of the data.

In a still further embodiment, active degrees may be at least divided into “hot,” “warm,” “cold,” and “archive” based on MRU values, wherein a data movement controller may be configured to, when an active degree of data is “hot,” keep data stored in real time at a real-time processing storage tier; when an active degree of data is changed to “warm,” store data at a high-performance storage tier; when an active degree of data is changed to “cold,” store data at a large-capacity storage tier; and when an active degree of data is changed to “archive,” store data at an archive storage tier.

In a yet further embodiment, a data storage management system may further include a data movement sub-module that may be configured to: when data is written into a higher storage device tier, synchronously or asynchronously copy all write operations of data to a lower storage device tier.

According to a further embodiment, a data storage management system may further include a utilization monitor configured to monitor utilization of a plurality of storage devices in a plurality of storage device tiers. In a further embodiment, a data movement controller may be configured to further control movement of the respective data among different storage device tiers based on utilizations of a plurality of storage devices in a plurality of storage device tiers.

According to a still further embodiment, a data movement controller may be configured to: when utilization of a storage device in a storage device tier reaches a predetermined use threshold, move data with a lowest active degree in a storage device tier to a lower storage device tier. According to a yet further embodiment, a data access monitor may include a plurality of access interceptors for corresponding tiers in a plurality of storage device tiers, and a plurality of access interceptors monitor access conditions of data in respective storage device tiers by monitoring data input/output in respective tiers.

According to one embodiment, a data storage management method may include monitoring access conditions of data stored in a plurality of storage devices, wherein a plurality of storage devices may be divided into a plurality of storage device tiers based on their respective characteristics. A further embodiment may include determining active degrees of respective data based on access conditions to respective data. A further embodiment may include controlling movement of respective data among a plurality of storage device tiers based on active degrees of respective data, such that the respective data may be stored in a storage device tiers adapted to their respective active degrees.

According to one embodiment, there is further provided a computer program product having program codes embodied thereon, when being executed on the processor, causing a processor to perform a data storage management method may include monitoring access conditions of data stored in a plurality of storage devices, wherein a plurality of storage devices may be divided into a plurality of storage device tiers based on their respective characteristics. A further embodiment may include determining active degrees of respective data based on access conditions to respective data. A further embodiment may include controlling movement of respective data among a plurality of storage device tiers based on active degrees of respective data, such that the respective data may be stored in a storage device tiers adapted to their respective active degrees. In one embodiment, data may be stored in storage devices of different storage device tiers based on different active degrees of data. In a further embodiment, this architecture is advantageous in providing high performance, open architecture may provide a good scalability.

Reference is first made to FIG. 1, which schematically shows a block diagram of data storage management system 100 according to one exemplary embodiment of the present disclosure. As shown in FIG. 1, data storage management system 100 comprises data access monitor 110, active degree meter 120, and data movement controller 130. A plurality of storage devices are divided into a plurality of storage device tiers based on their respective characteristics, e.g., tiers 302-1 to 302-4. Data access monitor 110 monitors access conditions of data stored in a plurality of storage devices in data center 300, and informs the monitored access conditions to active degree meter 120. Active degree meter 120 determines the active degrees of data based on the access conditions. Data movement controller 130 will control movement of the data among different storage device tiers in data center 160 based on the active degrees.

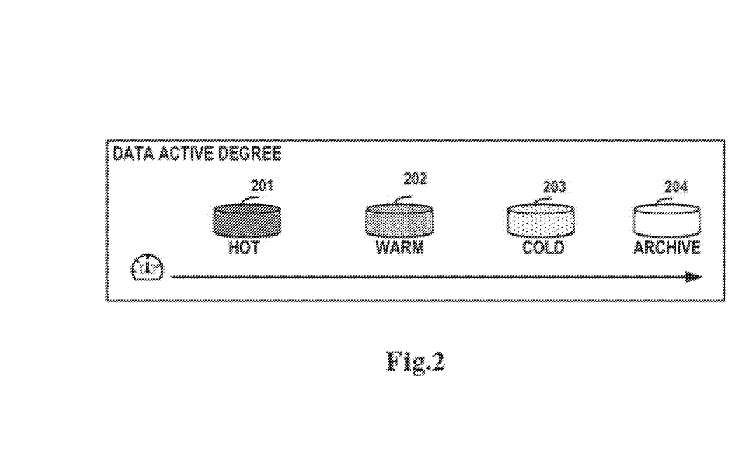

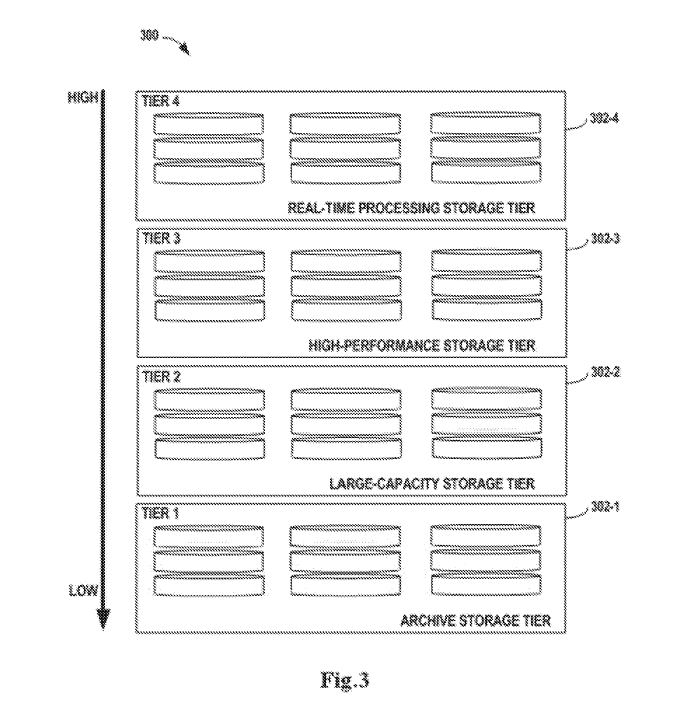

In one embodiment, a plurality of storage devices for storing data in a data center may be divided into a plurality of storage device tiers or clusters ranked in a descending order. In a further embodiment, storage device tiers may refer to a plurality of tiers or clusters which may be divided based on respective characteristics (e.g., capacity, access speed, etc.) of the storage device and used for storing data of different active degrees. In a further embodiment, an active degree of data may be an index indicating a probability or possibility of data to be used. In a further embodiment, generally, an active degree may gradually decrease with time. In a further embodiment, for illustration purposes, divisions of data active degrees and storage device tiers will be described in detail with reference to examples shown in FIGS. 2 and 3.

FIG. 2 illustrates a schematic diagram of active degrees division according to one exemplary embodiment of the present disclosure. Generally, data will be in a very active state (i.e., a larger possibility of being accessed) when data is just input and processed, but gradually becomes less active with the elapse of time and increase of access times. Based on this hypothesis, active degrees may be divided, but not limited to, into four levels, e.g., “hot” 201, “warm” 202, “cold” 203, and “archive” 204, as shown in FIG. 2. Therefore, when data is newly generated, its active degree is “hot” 201, while with elapse of time and gradual decrease of the possibility of accessing thereto, its active degree gradually becomes “warm” 202, then “cold” 203, and finally changes to “archive” 204 state.

In an example embodiment, “hot” data may be data that is just generated or inputted, which may be accessed immediately, i.e., having an extremely large access probability. In a further embodiment “warm” data may have a smaller access probability than “hot” data, but may still have a relatively large access probability. In a further embodiment “cold” data may have a relatively small access probability than “warm” data, but may still have a certain probability of being accessed. In a further embodiment “archive” data may have an even smaller probability than “cold” data, i.e., having a very small access probability, and may nearly not be accessed. In a further embodiment, if data at “cold” or “archive” state is accessed for multiple times, a state for the accessed data may reverses in all probability, i.e., changing from “archive” to “cold,” or from “cold” to “warm,” etc.

FIG. 3 illustrates an exemplary storage device tiers division according to one embodiment of the present disclosure. As shown in FIG. 3, the data storage devices are divided into, for example, 4 tiers, i.e., tier 1 to tier 4, wherein each tier is for storing data of a corresponding active degree. The lowest tier is tier 1, i.e., an archive storage tier, for storing “archive” data that has a very small access probability, and the storage device in this tier has a very low requirement on performance and governing parameters. Tier 2 is a large capacity storage tier, for storing “cold” data that has a relatively small access probability; although such “cold” data has a relatively small access probability, they have a large amount of data; and therefore, the storage device in this tier has a characteristic of a large capacity, but compared with the archive device, the performance requirement of the storage device can be a little higher. Tier 3 is a high-performance storage tier, for storing “warm” data that has a relatively large access probability; and therefore, the storage device in tier 3 has a characteristic of high performance, to match the characteristic of “warm” data. Tier 4 is the highest tier, i.e., a real-time processing storage tier, which has a characteristic of supporting real-time storage and processing simultaneously, e.g., a memory device.

Although FIGS. 2 and 3 show four active degrees and four storage device tiers corresponding to the four active degrees, it should be noted that, in fact, more or less active degree levels and storage device tiers may also be divided according to actual application needs.

Referring back to FIG. 1, description of operations of the components in storage management system 100 of the present disclosure will continued. Data access monitor 110 may be a separate data access monitor outside respective storage device tiers, or a plurality of access interceptors provided in respective storage device tiers, so as to monitor access conditions of data in respective storage device tiers. All data input/output (I/O) of the storage device in data center 160 go through the access monitor, and thus the I/O activities of data can be monitored by monitoring data I/O, thereby collecting conditions of data access.

Active degree meter 120 receives the access conditions of data reported by data access monitor 110 and determines, based thereupon, the active degrees of data. For example, active degree meter 120 may determine the active degree of data by determining the most recent use (MRU) value of the data. The MRU value is an index reflecting the recent access conditions of the data, which will vary with the access frequency. Therefore, an initial value may be assigned to the MRU value of the data when the data are just written to real-time processing storage tier 302-4 for real-time processing and analysis.

For example, for a value just outputted from the outside or for a value newly generated during the real-time processing process, an initial MRU value is assigned thereto when it is written into the memory. When the data are stored in real-time processing storage tier 302-4 or high-performance storage tier 302-3 and accessed, the MRU value of the data will decrease. This is because according to a life cycle of data, the data will always become increasingly inactive with the elapse of time and increase of use times.

On the other hand, when the data are stored in large-capacity storage tier 302-2 or archive storage tier 302-1 and accessed, the MRU value of the data increases. This is based on the hypothesis that frequent access to data that has become less active means an increase of its active degree. However, when data stored in large-capacity storage tier 302-2 is not accessed within a predetermined time period, the MRU value of the data decreases, because no access to the data in the large-capacity storage tier 302-2 within a predetermined time means decrease of the active degree of the data.

According to the MRU value of data, the active degree of the data may be determined, e.g., determining whether it is in a “hot,” (201) “warm,” (202) “cold” (203) or “archive” (204) level. For example, MRU thresholds or MRU value ranges corresponding to different levels of active degrees may be set. If the MRU value of data exceeds a specific MRU threshold or falls within a corresponding MRU value range, then the active degree of the data is in an active degree level corresponding to the specific MRU threshold or MRU range. Active degree meter 120 may transmit the calculated MRU value to data movement controller 130, and data movement controller 130 determines the active degree of the data based on the MRU value; or, active degree meter 120 determines the active degree of data after completing calculation of the MRU value, and then delivers it to data movement controller 130.

In an embodiment of the present disclosure, data movement controller 130 will move data among four tiers as shown in FIG. 3 based on the active degree of the data, such that data is automatically moved to a corresponding storage device tier. For example, moving from a higher tier to a lower tier, or moving from a lower tier to a higher tier, such that more active data are stored in a higher-tier storage device among the tiers, while less active data are stored in a lower tier storage device. For example, if data movement controller 130 determines that the active degree of data changes from “hot” to “warm,” data is moved from real-time processing storage hierarch 302-4 to high-performance storage tier 302-3. Again, if the active degree of data changes from “warm” to “cold,” then data is moved from high-performance storage tier 302-3 to large-capacity storage tier 302-2. Again, if the active degree of data changes to “archive,” data is moved from large-capacity storage tier 302-2 to archive storage tier 302-0, vice versa.

In this way, data having a higher active degree may be stored in a storage device having a higher performance so as to satisfy needs of higher-performance data processing, while for data having a lower active degree, they may be stored in a lower tier so as to support access to them while avoiding waste of storage resources. In this way, storage resources may be utilized more effectively, and meanwhile real-time processing and high-performance analysis to data may be supported simultaneously. Therefore, it not only provides high performance and open architecture, but also may have a good scalability.

Alternatively, data storage management system 100 further comprise a utilization monitor 140. Utilization monitor 140 is be used for monitoring utilizations of respective storage devices in data center 300. For example, utilization monitor 140 may periodically collect utilizations of respective storage devices in respective tiers, and report them to data movement controller 130. Data movement controller 130 may be further based on, in addition to the active degree of data, utilization of the storage device when it is to control data moving among respective storage device tiers. For example, when utilization of the storage device at the high performance storage device tier reaches a predetermined use threshold (e.g., 90%), a batch of data that is stored therein and have the lowest active degree (e.g., MRU value) is moved to the next tier, i.e., a large-capacity storage tier, so as to ensure that the high-performance storage device hierarch has sufficient space (e.g., 70%) to store data with a higher active degree.

Therefore, in the present disclosure, storage space in each tier is taken as a data ingress pool, which has a predetermined number of ingresses to serve incoming data. When data that needs to be entered is larger than a predetermined allowable ingress number, data with the smallest active degree (particularly MRU value) will be moved to the next storage device tier having a larger capacity. In this way, while moving data, not only the active degree of the data per se is considered, but also the storage capacity of the storage device per se may also be considered, thereby guaranteeing that the data with a higher active degree may have a higher processing performance.

Besides, in order to further optimize the performance, storage management system 100 may further comprise a data movement sub-module 150. Data movement sub-module 150 is configured to synchronously or asynchronously copy a write operation on data to the following lower tier. For example, while writing data into a memory, data and the subsequent write operation associated with the data may be copied into the high-performance storage tier and the large-capacity storage tier, so as to maintain a substantial synchronization with the data in the memory. The write operation associated with data includes, for example, modifying data per se, and writing or modifying a processing result and analysis result associated with the data. In this way, when the active degree of data is lowered and data is required to be moved to the next tier, and it is only required to delete the data in the memory while maintaining data in the following tier. Therefore, in a case that requires moving data, it is possible to avoid copying of mass data in short time, thereby further enhancing performance.

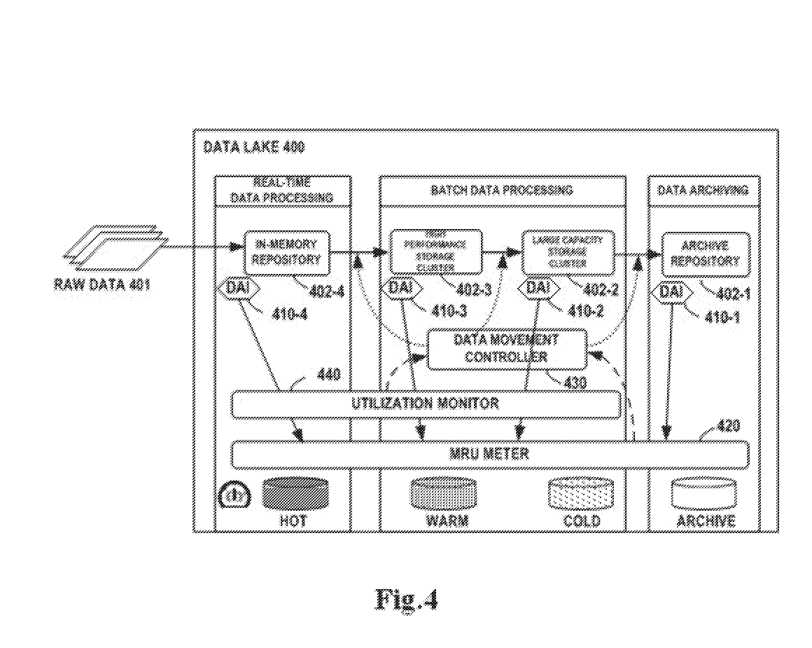

Next, for a purpose of illustration, reference will be made to FIG. 4 to describe a specific implementation of a data storage management system according to one exemplary embodiment of the present disclosure.

As shown in FIG. 4, data lake 400 comprises an in-memory repository 402-4, high-performance storage cluster 402-3, large-capacity storage cluster 402-2, and data archive cluster 402-1, which belong to a real-time processing storage tier, a high-performance storage tier, a large-capacity storage tier, and a data archive tier, respectively. In FIG. 4, with the arrival of a stable data flow of mass original data 401, data is first grouped into a data block to which a MRU initial value is assigned; and then the data block is written into in-memory repository 402-4, in real time. At this point, data is in a “hot” active degree level. Meanwhile, real-time analysis and processing is performed to the data block using a high-performance analysis tool.

MRU meter 430 determines the MRU value of the data block based on the data access conditions monitored by data access interceptor DAI 410-4 provided for the memory repository. For example, if data is accessed, MRU value will be decreased from the initial value. Meanwhile, utilization of storage devices at respective tiers is monitored using utilization monitor 440. If data movement controller 130 determines a change in the active degree of the data block based on the MRU value and the preset threshold value or value range, e.g., changing from “hot” to “warm,” or the utilization of the memory repository reaches a certain threshold (e.g., 90%), data movement controller 410 performs control in order to move the data block and its analysis result out of in-memory repository 402-4 and downward to a lower storage device tier having a capability of permanent storage, i.e., high-performance storage cluster 402-3. At the same time, DAI 410-3 provided for high-performance storage cluster 402-3 monitors access to data in the high-performance storage cluster, and MRU meter 420 determines a current MRU value of the data block based on the access conditions of the data. When data movement controller 430 determines, based on the current MRU value of the data block, that the active degree of the data block changes from “warm” to “cold,” or total utilization of the storage devices of high-performance storage cluster 402-3 reaches a certain threshold (e.g., 90%), it moves the data block from high-performance storage cluster 402-3 to large-capacity storage cluster 402-2.

However, it should be noted that for data blocks in both high-performance storage cluster 402-3 and large-capacity storage cluster 402-2, batch processing data analysis can be performed, except for data in the high-performance storage cluster, it will obtain a higher data processing and analysis performance When the DAI 410-2 provided specifically for the large-capacity storage cluster monitors an access condition and finds that the access frequency for the data block continuously decreases, e.g., changing from “cold” to “archive,” the data block and its relevant analysis result will be archived and kept in archive storage cluster 402-1.

On the other hand, when data stored in a lower hierarchy is accessed, MRU value will change reversely; while increase of MRU value causes change of the active degree level, the data block will be moved from a lower tier to a higher tier. For example, if data in large-capacity storage cluster 402-2 is accessed, their MRU value will be increased; when such increase causes the MRU value of the data block to reach the threshold of the “warm” active degree or fall within the MRU value range corresponding to “warm,” the data block may be moved from lower-tier large capacity storage cluster 420-2 up to higher-tier high-performance storage cluster 420-3.

Hereinabove, the specific implementation as shown in FIG. 4 has been introduced for a specific data block from the perspective of a data life cycle. However, in an actual application, multiple DAIs 410-1 to 410-4, MRU meter 420, utilization monitor 440, and data movement controller perform their own work for mass data. In particular, DPI 410-1 to 410-4 are respectively responsible for monitoring data access conditions in corresponding tiers, and reporting the access conditions to MRU meter 420 periodically or when data is being accessed. MRU meter 420 calculates MRU values of respective data based on the reported access conditions. Utilization monitor 440 monitors utilization of storage devices in respective tiers. Data movement controller 430 determines which data blocks need to be moved based on the MRU values of respective data and utilization of storage devices. For example, if it is determined that the active degree level of data has been changed, data movement controller 430 performs control so as to move the data block, thereby storing them in the storage tier corresponding to its active degree. If the utilization of the storage devices at a certain storage device tier reaches a predetermined threshold (e.g., 90%), data movement controller 430 performs control to move part of data with the lowest MRU value to a lower tier, although they might have not reached the active degree level of the next tier yet. For the data block moved into the next tier due to utilization of the storage device exceeding a predetermined threshold, its data active degree may be reduced to the MRU value corresponding to the next tier.

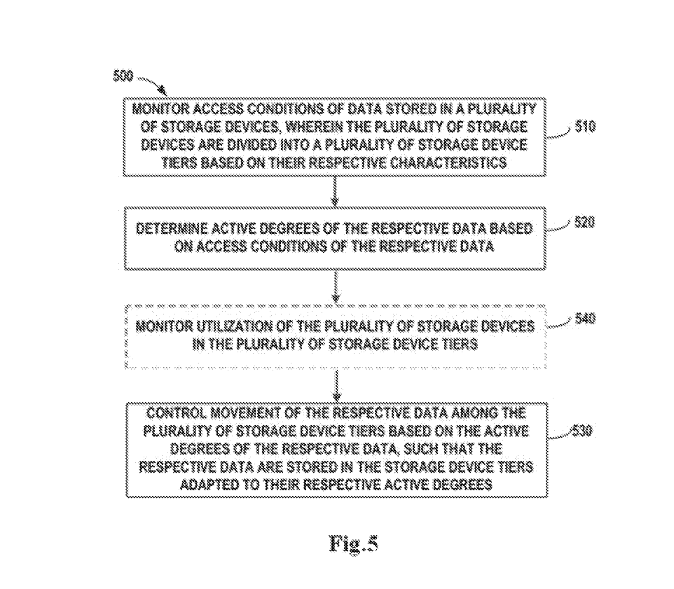

Besides, the present disclosure further provides a data storage management method. Hereinafter, reference will be made to FIG. 5, which illustrates a flow diagram 500 of a data storage management method according to one exemplary embodiment of the present disclosure.

As shown in FIG. 5, first in step 510, access conditions of data stored in a plurality of storage devices is monitored, wherein the plurality of storage devices are divided into a plurality of storage device tiers based on their respective characteristics. Next, in step 520, active degrees of the respective data are determined based on access conditions of respective data. In step 530, movement of respective data among a plurality of storage device tiers is controlled based on the active degrees of the respective data, such that the respective data is stored in the storage device tiers adapted to their respective active degrees. Utilization of a plurality of storage device tiers may also be monitored in step 540

In one embodiment, in particular, a plurality of storage device tiers may at least include a real-time processing storage tier, a high-performance storage tier, a large-capacity storage tier, and an archive storage tier in descending ranks. In a further embodiment, monitoring operations may be performed for storage device classes in respective tiers, which may be performed in a collective manner or in a distributive manner. In a further embodiment, data input/output in respective tiers may be monitored to obtain the access conditions for data in respective storage device tiers. In one embodiment, active degrees of respective data may be determined by determining the most recent use MRU values of the respective data.

In a further embodiment, in particular, when data is written into a real-time processing storage tier, an initial value may be assigned to a MRU value of the data. In a further embodiment, when data stored in a real-time processing storage tier or a high-performance storage tier is accessed, a MRU value of the data may be decreased. In a further embodiment, when data stored in a large-capacity storage tier or an archive storage tier is accessed, a MRU value of the data may be increased. In a further embodiment, when data stored in a large capacity storage tier is not accessed within predetermined time, a MRU value of the data may be decreased.

In a further embodiment, an active degree may be at least divided into “hot,” “warm,” “cold” and “archive” based on a MRU value. In a further embodiment, division may be based on a preset threshold or a value range corresponding to a respective active degree levels. In a further embodiment, if a MRU value of data reaches a predetermined threshold or falls within a predetermined value range, then an active degree of the data may be in a level corresponding to the predetermined threshold or value range.

In a further embodiment, movement of a respective data among a plurality of storage device tiers may be controlled based on active degrees of respective data, such that respective data may be stored in a storage device tiers adapted to their respective active degrees. In a further embodiment, in particular, more active data may be stored in a higher ranking storage device, while less active data are stored in a lower ranking storage device. In an example embodiment, when an active degree of data is “hot,” data may be stored in real tie at a real-time processing storage tier. In a further embodiment, when active degree of the data becomes “warm,” data may be stored in a high-performance storage tier. In a further embodiment, when active degree of data becomes “cold,” data may be stored in a large-capacity storage tier. In a further embodiment, when active degree of data becomes “archive,” data may be stored in an archive storage tier.

In a further embodiment performance may be optimized, when data may be written into a higher storage device tier, all write operations on data may be synchronously or asynchronously copied to a lower ranking storage device tier. In an example embodiment, when data is written into a memory, data and subsequent write operation associated with the data may be copied into a high-performance storage tier and a large-capacity storage tier, to maintain a substantial synchronization with the data in the memory. In a further embodiment, in a case moving data is required, copying mass data in a short time may be avoided, thereby further enhancing performance.

In a further embodiment, utilization of a plurality of storage device tiers may also be monitored. In a further embodiment, movement of respective data among a plurality of different storage device tiers may be further controlled based on utilization of a plurality of storage devices in a plurality of storage device tiers. In a further embodiment, in particular, when utilization of a storage device in a storage device tier reaches a predetermined use threshold, data with a lowest active degree in a storage device tier may be moved to a lower rank storage device tier.

In a further embodiment, it should be noted that a data storage management solution of the present disclosure may also be implemented through a computer program product. The computer program has program code embodied thereon, which, when being executed by a processor, causes the processor to perform a data storage management method according to the present disclosure.

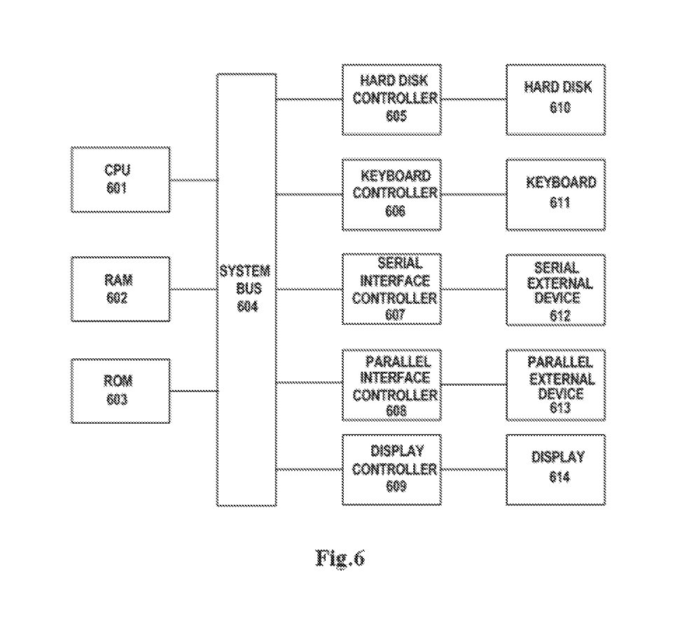

Hereinafter, FIG. 6 will be referenced to describe a computer device in which the embodiments of the present disclosure may be implemented. FIG. 6 schematically shows a structural block diagram of a computer device which can implement the embodiment of the present disclosure. It should be noted that what is illustrated below is only an example, and in actual applications, many components therein may be deleted, added, replaced, and modified according to the needs of implementing a data storage management solution.

As illustrated in FIG. 6, the computer system comprises CPU (Central Processing Unit) 601, RAM (Random Access Memory) 602, ROM (Read Only Memory) 603, system bus 604, hard disk controller 605, keyboard controller 606, serial interface controller 607, parallel interface controller 608, display controller 609, hard disk 610, keyboard 611, serial peripheral device 612, parallel peripheral device 613 and display 614. Among these components, connected to system bus 604 are CPU 601, RAM 602, ROM 603, hard disk controller 605, keyboard controller 606, serial interface controller 607, parallel interface controller 608 and display controller 609. Hard disk 610 is connected to hard disk controller 605; keyboard 611 is connected to keyboard controller 606; serial peripheral device 612 is connected to serial interface controller 607; parallel peripheral device 613 is connected to parallel interface controller 608; and display 614 is connected to display controller 609. It should be understood that the structural block diagram in FIG. 6 is illustrated only for illustration purpose, and is not intended to limit the invention. In some cases, some devices can be added or reduced as required.

The embodiments of the present disclosure may be stored in a storage device of a computer such as hard disk 610 as computer program code, which, when being loaded into for example a memory and executed, causes CPU 601 to perform the data storage management method according to the present disclosure.

It should be noted that embodiments of the present disclosure may be implemented by software and/or combination of software and hardware. The data storage management solution provided by the present disclosure has been described above in detail through the embodiments with reference to the accompanying drawings. However, those skilled in the art should understand that although the text data are described with a log in the form of text stream as an example, the present disclosure is not limited to log data. Actually, any other appropriate text data may be compressed using the solution of the present disclosure; moreover, the text data is not necessarily in the form of text stream. Additionally, the description given above is made with a distributed system or SaaS as an example. However, the present application may also be applied to other similar scenarios. In addition, the weight calculation shown above is also exemplary. In actual applications, the weight may also be calculated in a different manner, e.g., adopting a different algorithm, considering more or less factors, etc. In addition, it may also be understood that based on the disclosure and teaching here, those skilled in the art may also envisage various modifications, alterations, replacements or equivalents, without departing from the spirit and scope of the present disclosure. These modifications, alterations, replacements or equivalents are all included within the scope of the present disclosure only limited by the claims.

The embodiments of the present disclosure may be implemented in a combination, e.g., may be implemented using by an application-specific integrated circuit (ASIC), a general-purpose computer or any other similar hardware device. In one embodiment, a software program of the present disclosure may be executed by a processor to implement the steps or functions described above. Likewise, the software program (including a relevant data structure) of the present disclosure may be stored in a computer-readable recording medium, e.g., a RAM memory, a magnetic or optical driver or a soft floppy and like devices. In addition, some steps or functions of the present disclosure may be implemented by hardware, e.g., as a circuit cooperating with the processor to perform respective steps or functions.

Additionally, part of the present disclosure may be applied as a computer program product, e.g., a computer program instruction, which, when being executed by the computer, may invoke or provide the method and/or technical solution according to the present disclosure through operation of the computer. However, the program instruction invoking the method of the present disclosure may be stored in a fixed or mobile recording medium, and/or transmitted through a data stream in broadcast or other signal carrier medium, and/or stored in a working memory of a computer device running according to the program. Here, one embodiment according to the present disclosure may include an apparatus that includes a memory for storing computer program instructions and a processor for performing program instructions, wherein when the computer program instruction is executed by the processor, the apparatus is triggered to execute the method and/or technical solution based on the plurality of embodiments according to the present disclosure.

To those skilled in the art, it is apparent that the present disclosure is not limited to the details of the above exemplary embodiment, and the present application may be implemented in other specific implementations without departing from the spirit or basic feature of the present disclosure. Therefore, in any aspect, the embodiments should be regarded as illustrative, rather than limitative. The scope of the present disclosure is limited by the appended claims, rather than by the above description. Therefore, all variations falling into the meanings and scope of the equivalent elements in the claims are covered within the present disclosure. No reference numeral in the claims should be regarded as limiting the involved claims. Additionally, it is apparent that the word “comprise” does not exclude other elements or steps, and a singular form does not exclude plurality. A plurality of units or means as stated in the apparatus claims may also be implemented by one unit or apparatus through software or hardware. Terms like first and second are used to represent names, not indicating any specific order.

What is claimed is:

1. A data storage management system, comprising computer-executable logic operating in memory, wherein the computer-executable program logic is configured to enable execution across one or more processors configured to:
monitor access conditions of data stored in a plurality of storage devices, wherein the plurality of storage devices are divided into a plurality of storage device tiers based on their respective characteristics;
determine active degrees of a respective data based on the access conditions of the respective data;
control movement of the respective data among the plurality of storage device tiers based on the active degrees of the respective data, the respective data being stored in the storage device tiers adapted to their respective active degrees.

2. The data storage management system according to claim 1, wherein the plurality of storage device tiers comprise at least one from the group consisting of: a real-time processing storage tier, a high-performance storage tier, a large-capacity storage tier, and an archive storage tier ranked in a descending order, and configured to store relatively active data in a higher-tier storage device and store less active data in a lower-tier storage device.

3. The data storage management system according to claim 2, further configured to determine the active degrees of the respective data by determining most recently use (MRU) values of the respective data.

4. The data storage management system according to claim 3, further configured to:
when the data is written into the real-time processing storage tier, assign an initial value to the MRU value of the data;
at least one of when the data stored in the real-time processing storage tier or the high-performance storage tier is accessed, decrease the MRU value of the data;
at least one of when the data stored in the large-capacity storage tier or the archive storage tier is accessed, increase the MRU value of the data; and
when the data stored in the large-capacity storage tier is not accessed in a predetermined time period, decrease the MRU value of the data.

5. The data storage management system according to claim 3, wherein based on the MRU values, the active degrees are at least divided into “hot,” “warm,” “cold,” and “archive”.

6. The data storage management system according to claim 5, further configured to:
when the active degree of the data is “hot,” retain the data stored in real-time at the real-time processing storage tier;
when the active degree of the data is changed to “warm,” store the data at the high-performance storage tier;
when the active degree of the data is changed to “cold,” store the data at the large-capacity storage tier; and
when the active degree of the data is changed to “archive,” store the data at the archive storage tier.

7. The data storage management system according to claim 1, further configured to: when data is written into a higher storage device tier, synchronously or asynchronously copy all write operations on the data to a lower storage device tier.

8. The data storage management system according to claim 1, further configured to monitor utilization of a plurality of storage devices in the plurality of storage device tiers, and to control movement of the respective data among the different storage device tiers further based on utilization of the plurality of storage devices in the plurality of storage device tiers.

9. The data storage management system according to claim 7, further configured to: when utilization of a storage device in a storage device tier reaches a predetermined use threshold, move the data with the lowest active degree in the storage device tier to a lower storage device tier.

10. The data storage management system according to claim 1, wherein the data access monitor includes a plurality of access interceptors for corresponding tiers in the plurality of storage device tiers, and the plurality of access interceptors monitor access conditions of the data in respective storage device tiers by monitoring the data input/output in respective tiers.

11. A data storage management method, the method comprising:
monitoring access conditions of data stored in a plurality of storage devices, wherein the plurality of storage devices are divided into a plurality of storage device tiers based on their respective characteristics;
determining active degrees of a respective data based on the access conditions of the respective data;
controlling movement of the respective data among the plurality of storage device tiers based on the active degrees of the respective data, such that the respective data are stored in the storage device tiers adapted to their respective active degrees.

12. The data storage management method according to claim 11, wherein the plurality of storage device tiers at least at least one from the group consisting of a real-time processing storage tier, a high-performance storage tier, a large-capacity storage tier, and an archive storage tier ranked in a descending order; and relatively active data is stored in a higher-tier storage device while less active data is stored in a lower-tier storage device.

13. The data storage management method according to claim 12, wherein the determining active degrees of the respective data based on access conditions of respective data comprises determining most recently use (MRU) values of the respective data.

14. The data storage management method according to claim 13, further comprising:
when the data is written into the real-time processing storage tier, assigning an initial value to the MRU value of the data;
at least one of, when the data stored in the real-time processing storage tier or the high-performance storage tier is accessed, decreasing the MRU value of the data;
at least one of, when the data stored in the large-capacity storage tier or the archive storage tier is accessed, increasing the MRU value of the data; and
when the data stored in the large-capacity storage tier is not accessed in a predetermined time period, decreasing the MRU value of the data.

15. The data storage management method according to claim 13, wherein the active degrees are at least divided into “hot,” “warm,” “cold,” and “archive” based on the MRU values.

16. The data storage management method according to claim 15, the method further comprising:
when the active degree of the data is “hot,” retaining the data at the real-time processing storage tier in real time;
when the active degree of the data is changed to “warm,” storing the data at the high-performance storage tier;
when the active degree of the data is changed to “cold,” storing the data at the large-capacity storage tier; and
when the active degree of the data is changed to “archive,” storing the data at the archive storage tier.

17. The data storage management method according to claim 11, further comprising:
when data is written into a higher storage device tier, synchronously or asynchronously copying all write operations on the data to a lower storage device tier.

18. The data storage management method according to claim 11, further comprising:
monitoring utilizations of a plurality of storage devices in the plurality of storage device tiers, and
controlling movement of the respective data among the different storage device tiers further based on the utilizations of the plurality of storage devices in the plurality of storage device tiers.

19. The data storage management method according to claim 17, further comprising:
when utilization of a storage device in a storage device tier reaches a predetermined use threshold, moving the data with the lowest active degree in the storage device tier to a lower storage device tier.

20. A computer program product comprising a non-transitory computer readable medium encoded with computer executable program code, wherein the code enables execution across one or more processors for:
monitoring access conditions of data stored in a plurality of storage devices, wherein the plurality of storage devices are divided into a plurality of storage device tiers based on their respective characteristics;
determining active degrees of a respective data based on the access conditions of the respective data;
controlling movement of the respective data among the plurality of storage device tiers based on the active degrees of the respective data, such that the respective data are stored in the storage device tiers adapted to their respective active degrees.
